(19) United States
(12) Patent Application Publication
(10) Pub. No.: US 2015/0357969 A1
(43) Pub. Date: Dec. 10, 2015

(54) COOLING METHOD AND SYSTEM FOR PHOTOVOLTAIC SOLAR PANELS

(71) Applicant: Fernando FERNANDEZ DE CÓRDOBA SANZ, (US)

(72) Inventor: Fernando FERNANDEZ DE CÓRDOBA SANZ, ALCOBENDAS (ES)

(21) Appl. No.: 14/760,125

(22) PCT Filed: Jan. 9, 2014
(86) PCT No.: PCT/ES2014/070010

§ 371 Date: Jul. 9, 2015

(30) Foreign Application Priority Data
Jan. 11, 2013 (ES) P201330023

(51) Int. Cl. H02S 40/42; H02S 40/10

(52) U.S. Cl. CPC H02S 40/425; H02S 40/10

(57) ABSTRACT

The present invention relates to a cooling system and method for photovoltaic solar panels. The cooling system and method allow reducing the temperature of the outer surface of photovoltaic solar panels, hereinafter PV panels (2), thereby maximizing their performance and keeping their surface at optimal operating temperatures (about 25° C.) at all times, while at the same time allowing cleaning and eliminating dust and/or fouling residues on said surface, even further optimizing, if possible, the total performance of said PV panels (2).

### OBJECT OF THE INVENTION

The present invention belongs to the field of renewable energies, and more specifically to cooling apparatuses or means for photovoltaic solar panels.

The main object of the present invention is a cooling system and a cooling method for photovoltaic solar panels that allow increasing their performance by keeping their surface at optimal temperature values, while at the same time it allows cleaning dust or fouling residues off of said surface, even further optimizing, if possible, the final work and performance of said panels.

### BACKGROUND OF THE INVENTION

Installations consisting of photovoltaic solar panels, hereinafter PV panels, for obtaining electricity directly from solar radiation, through a plurality of semiconductor devices (photovoltaic cells) installed in said PV panels, are well-known today. More particularly, there are basically three types of installations for producing electric power based on the photovoltaic effect: solar installation with a fixed plate; installation with single-axis solar tracking; installation with dual-axis solar tracking.

In all of them, the system for generating electric power is the same, i.e., a material manufactured for that purpose (mono- or polycrystalline photoelectric silicon cell, or thin film silicon amorphous), it absorbs the luminous photons coming from solar radiation, and as they enter an excitation state, said photoelectric cells release energy by emitting free electrons (electricity). This is known as the photovoltaic effect.

There are currently several countries which have passed suitable laws and regulations for encouraging the establishment of solar installations and thus having a non-depletable, clean and renewable energy source. Virtually from the onset of solar technology, the tests conducted in various laboratories have determined that the optimal operating temperature of the PV panels is in the range comprised between 20 and 30° C., assuming that there will always be a series of losses generated as a result of the photovoltaic cells working at temperatures exceeding the optimal temperature, generally between 40-60° C. and even higher, due to the heating of the cells by the action of solar radiation. This causes the PV panels to frequently work below their ideal performance of 100%. Furthermore, another detrimental side effect of said overheating is the early deterioration of the PV panels, their service life being shortened and having a much lower performance after a few years of operation.

Therefore, current attempts to avoid said temperature increase in solar panels have been unsuccessful primarily due to the fact that even though there are cooling systems capable of controlling the panel heating effect, the economic and energy cost thereof is generally very high and is not worth it for investing companies because the vast majority of them use electricity to run additional cooling machines. Furthermore, they are also unable to remove the dust covering the surface, likewise affecting their performance. Therefore, most solar installations today are exposed to the elements, without any thermal protection of any type.

In summary, the drawbacks of current photovoltaic solar panels are mainly:
They work at a temperature above their optimal operating value, which causes a substantial loss in their performance.
They accumulate a layer of dust, particles and fouling that are deposited on their surface, negatively affecting their performance.
The preceding points cause early deterioration of the internal components of said PV panels, hence affecting their normal operation.
Furthermore, the preceding point causes the associated repair, replacement and maintenance costs for parts to rise considerably, thereby increasing the cost of the installation.

### DESCRIPTION OF THE INVENTION

The present invention solves the aforementioned drawbacks by providing a cooling system and method for photovoltaic solar panels, hereinafter PV panels, which allow increasing the performance of solar panels by keeping their surface at optimal operating temperature values, while at the same time it allows cleaning and removing dust and/or fouling residue existing on said surface, even further optimizing, if possible, their final performance.

More particularly, the cooling system object of invention is particularly applicable to PV panels of the type that are installed in an inclined position with respect to the horizontal plane for optimal solar radiation capture, said cooling system comprising fluid sprayers arranged on the upper edge of the PV panels for supplying a continuous or discontinuous sheet of fluid over the outer surface of the PV panels; a collection tray fixed to the lower edge of the PV panels to collect and channel the excess fluid coming from said outer surface of the PV panels; a drain hose linked at one of its ends to the collection tray to extract the fluid housed in the collection tray.

Furthermore, the cooling system of the present invention comprises a first tank arranged outdoors for storing and cooling the fluid extracted through the drain hose, and a second thermally insulated tank suitable for receiving the low-temperature fluid coming from the first tank by means of an electric pump, said second tank having an outlet duct for recirculating the fluid back towards the fluid sprayers of the PV panels.

It should be indicated that with said second thermally insulated tank that is insulated by means of polyurethane foam, for example, the fluid does not experience significant temperature variations for the longest possible time in order to be recirculated back to the fluid sprayers.

In turn, although the electric pump is preferably connected to the power grid, it has been envisaged that the cooling system herein described may comprise a standalone solar panel equipment for the additional power supply of said electric pump.

On the other hand, the fluid sprayers discussed above are preferably located on an elongated common rod installed along the upper edge of the PV panels, said fluid sprayers being able to be sprinklers, micro sprinklers, drip sprayers, sheet sprayers or the like. In turn, the electric pump is preferably a combined, lift-force pump, and it is associated with a control unit managing the power supply to be provided to the pump.

It has also been envisaged that the fluid sprayers additionally comprise flow rate regulating means that allow the outflow of a larger or smaller amount of fluid according to the cooling needs of the PV panels, i.e., by balancing out the excessive heat that the PV panels may have during the day so that their performance is always close to 100%.

According to another object of the invention, a cooling method for PV panels is described below, said method comprising the following steps:
outflow of fluid over the outer surface of the PV panels from fluid sprayers located on the upper edge thereof,
collecting and channeling the excess fluid in a collection tray,
extracting the fluid housed in the collection tray by means of a drain hose,
storing and cooling the extracted fluid in a first tank located outdoors until said fluid reaches a minimum temperature,
pumping the fluid once it is cooled to a second thermally insulated tank, and
recirculating the fluid from the second tank towards the fluid sprayers of the PV panels.

The step of storing and cooling the fluid in the first tank is preferably performed until the time of day with the lowest outdoor temperature (which will generally be in the early morning hours every day).

Likewise, the step of recirculating fluid back towards the fluid sprayers of the PV panels is preferably performed by means of draining by gravity through the outlet duct of the aforementioned second tank, thereby providing simplicity, speed and a low economic cost of the installation.

### DESCRIPTION OF THE DRAWINGS

To complement the description that is being made and for the purpose of aiding to better understand the features of the invention according to a preferred practical embodiment thereof, a set of drawings is attached as an integral part of said description in which the following has been depicted with an illustrative and non-limiting character:

FIG. 1 shows a schematic view of the different elements involved in the cooling system for photovoltaic solar panels object of invention.

FIG. 2 shows a perspective view of a photovoltaic solar panel incorporating the cooling system of the present invention.

### PREFERRED EMBODIMENT OF THE INVENTION

A preferred embodiment is described below making reference to the aforementioned drawings, without this limiting or reducing the scope of protection of the present invention.

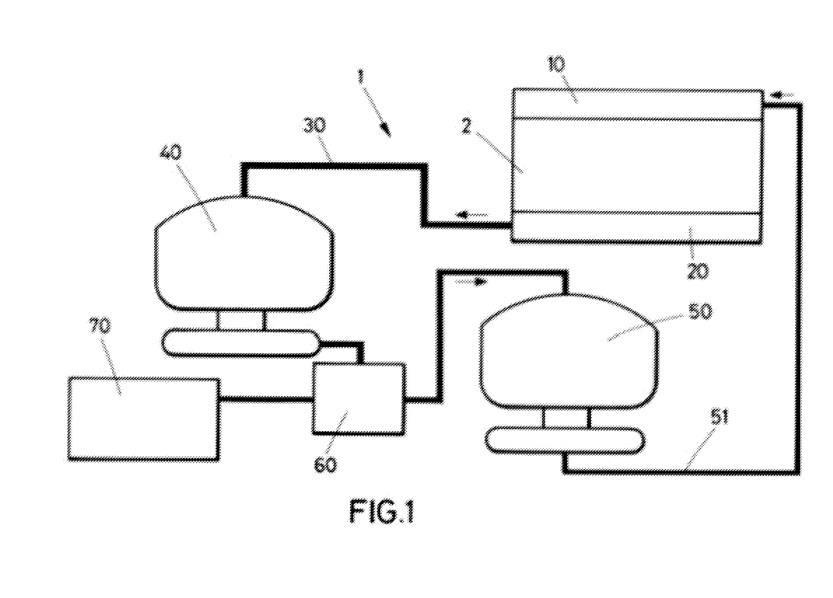

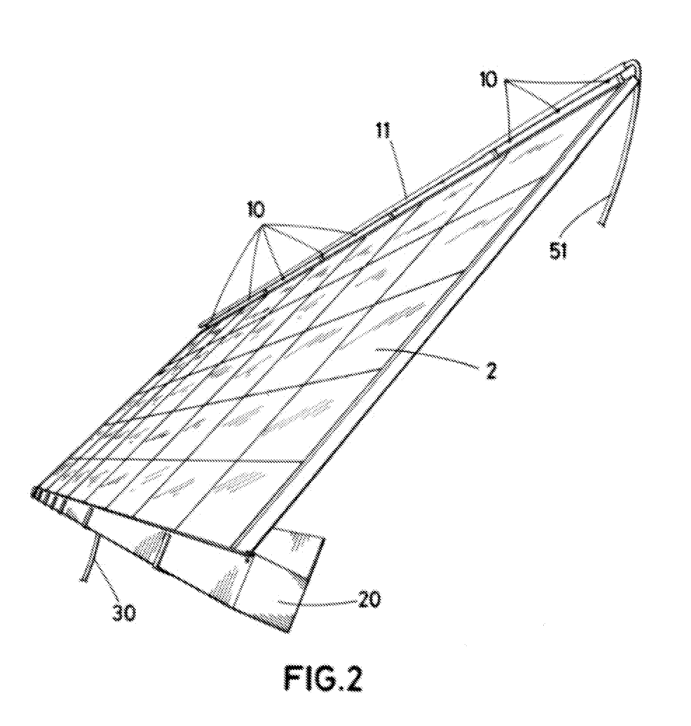

FIG. 1 schematically shows the different component elements of the cooling system of the invention, which comprises:
fluid sprayers (10), shown more clearly in FIG. 2, located on an elongated common rod (11) installed along the upper edge of the PV panels (2), which allow supplying a sheet of fluid over the outer surface of said PV panels (2),
a collection tray (20) fixed to the lower edge of the PV panels (2) to collect and channel the excess fluid coming from said outer surface of the PV panels (2),
a drain hose (30) linked at one of its ends to the collection tray (20) to extract the fluid housed in the collection tray (20),
a first tank (40) arranged outdoors for storing and cooling the fluid extracted through the drain hose (30), and
a second thermally insulated tank (50) that is suitable for receiving the low-temperature fluid coming from the first tank (40) by means of an combined electric pump (60), said second tank (50) having an outlet duct (51) for recirculating the fluid towards the fluid sprayers (10) of the PV panels (2), and
a standalone solar panel equipment (70) for the additional power supply of the electric pump (60).

Therefore, the present invention provides a closed cooling circuit for PV panels (2) which allows reducing the temperature of their outer surface to an optimal operating value (about 25° C.), said panels (2) being cooled based on the outside temperature at the most favorable time of day, i.e., when the outside temperature is the minimum temperature, and also removing fouling and dust residues that may be covering the outer surface of said PV panels (2).

1. A cooling system (1) for photovoltaic solar panels (2), of the type that are installed in an inclined position with respect to the horizontal plane for optimal solar radiation capture, characterized in that it comprises:
fluid sprayers (10) arranged on the upper edge of the PV panels (2) for supplying a sheet of fluid over their outer surface,
a collection tray (20) fixed to the lower edge of the PV panels (2) to collect and channel the excess fluid coming from said outer surface of the PV panels (2),
a drain hose (30) linked at one of its ends to the collection tray (20) to extract the fluid housed therein,
a first tank (40) arranged outdoors for storing and cooling the fluid extracted through the drain hose (30), and
a second thermally insulated tank (50) that is suitable for receiving the low-temperature fluid coming from the first tank (40) by means of an electric pump (60), said second tank (50) having an outlet duct (51) for recirculating the fluid towards the fluid sprayers (10) of the PV panels (2).

2. The cooling system (1) for photovoltaic solar panels (2) according to claim 1, characterized in that it additionally comprises a standalone solar panel equipment (70) for the additional power supply of the electric pump (60).

3. The cooling system (1) for photovoltaic solar panels (2) according to claim 1, characterized in that the fluid sprayers (10) are located on an elongated common rod (11) installed along the upper edge of the PV panels (2).

4. The cooling system (1) for photovoltaic solar panels (2) according to claim 1, characterized in that the fluid sprayers (10) are sprinklers, micro sprinklers, drip sprayers, sheet sprayers or the like.

5. The cooling system (1) for photovoltaic solar panels (2) according to claim 1, characterized in that the fluid sprayers (10) additionally comprise flow rate regulating means.

6. The cooling system (1) for photovoltaic solar panels (2) according to claim 1, characterized in that the electric pump (60) is a combined, lift-force pump.

7. The cooling system (1) for photovoltaic solar panels (2) according to claim 1, characterized in that the electric pump (60) is associated with a control unit managing the power supply to be provided to the pump (60).

8. A cooling method for photovoltaic solar panels, characterized in that it comprises the following steps:
outflow of fluid over the outer surface of the PV panels (2) from fluid sprayers (10) located on the upper edge thereof,
collecting and channeling the excess fluid in a collection tray (20),
extracting the fluid housed in the collection tray (20) by means of a drain hose (30),
storing and cooling the extracted fluid in a first tank (40) located outdoors until said fluid reaches a minimum temperature,
pumping the fluid once it is cooled to a second thermally insulated tank (50), and
recirculating the fluid from the second tank (50) towards the fluid sprayers (10) of the PV panels (2).

9. The cooling method according to claim 8, characterized in that the step of storing and cooling the fluid in the first tank (40) is performed until the time of day with the lowest outdoor temperature.

10. The cooling method according to claim 8, characterized in that the step of recirculating fluid is performed by means of draining by gravity.
